(19) United States
(12) Patent Application Publication
(10) Pub. No.: US 2026/0003985 A1
(43) Pub. Date: Jan. 1, 2026

(54) FILE SHARING AND TRANSFER IN A SECURE DEVICE ECOSYSTEM

(71) Applicant: QUALCOMM Incorporated, San Diego, CA (US)

(72) Inventors: Abhishek GHOSH, Kolkata (IN); Sumit RANA, Delhi (IN); Uttkarsh JHA, Araria (IN); Manish GARG, Hyderabad (IN); Pratibind Kumar JHA, Hyderabad (IN); Kiran Anil CHIKODI, Belagavi (IN); Anwesha NAYAK, Jajpur (IN); Mohd Suhel SUDDIQUI, Hyderabad (IN); Chinna Lakshman PARA, Hyderabad (IN); Anusha HARLAPUR, Dharwad (IN); Varada Mohan Reddy NANDYALA, Hyderabad (IN)

(21) Appl. No.: 18/757,868

(22) Filed: Jun. 28, 2024

(51) Int. Cl. G06F 21/62; G06K 7/14; H04L 67/06

(52) U.S. Cl. CPC G06F 21/6218; G06K 7/1413; G06K 7/1417; H04L 67/06

(57) ABSTRACT

This disclosure provides methods, components, devices and systems for providing file sharing and transfer in a secure device ecosystem. Some aspects more specifically relate to utilizing communications with trusted devices in a secure device ecosystem to display a file at a display device and provide access to the file to a requesting device access to the file using information gathered from the display of the file. The requesting device may access or obtain the file from various places in the secure device ecosystem including a repository associated with a network device and a distributed context file repository distributed among several contributing devices in the secure device ecosystem.

### TECHNICAL FIELD

This disclosure relates generally to wireless communication, and more specifically, to accessing and transferring files between devices in a secure device ecosystem in a wireless network.

### DESCRIPTION OF THE RELATED TECHNOLOGY

Wireless communication networks may include various types of wireless communication devices including network entities (such as wireless access points (AP) or base stations (BS)), client devices (such as wireless stations (STAs) or user equipment (UEs)), and other wireless nodes. These wireless communication devices may communicate with one another via a variety of technologies and wireless communication protocols, including wireless local area network (WLAN) or Wi-Fi-based protocols or cellular (such as 4G, 5G, or 6G)-based protocols. The wireless communication networks may be capable of supporting communication with multiple users by sharing the available system resources (such as time, frequency, and spatial resources). To enable features or provide improved performance, the wireless communication devices may employ technologies such as orthogonal frequency divisional multiple access (OFDMA), multi-user Multiple-Input Multiple-Output (MU-MIMO), spatial multiplexing, and beamforming. For greater inter-operability, the wireless communication networks may support backwards compatibility (such as supporting legacy wireless communication devices) as well as forward compatibility (such as supporting communication with wireless communication devices compatible with next-generation wireless communication standards).

### SUMMARY

The systems, methods and devices of this disclosure each have several innovative aspects, no single one of which is solely responsible for the desirable attributes disclosed herein.

One innovative aspect of the subject matter described in this disclosure can be implemented in a wireless station. The wireless station includes a processing system that includes one or more processors and one or more memories coupled with the one or more processors. The processing system is configured to cause the wireless station to capture, using an image sensor at the wireless station, file identification information for a file displayed from a secure device ecosystem and output a file transfer request for the file via the secure device ecosystem, where the file transfer request includes the captured file identification information. The processing system is also configured to obtain the file.

In some examples, the processing system is further configured to cause the wireless station to capture, using the image sensor, a unique identification (ID) generated for the file, where the unique ID includes a storage location for the file within the secure device ecosystem, and where the file identification information includes the unique ID, and obtain the file using the storage location in the unique ID.

In some examples, the file is a component of a distributed context file repository distributed among one or more contributing devices in the secure device ecosystem, where the storage location identifies the storage location at a location device of the one or more contributing devices. In some examples, the processing system is further configured to cause the wireless station to obtain the file from the location device.

Another innovative aspect of the subject matter described in this disclosure can be implemented in a wireless communication network device. The network device includes a processing system that includes one or more processors and one or more memories coupled with the one or more processors. The processing system is configured to cause the network device to provide, to a first device in a secure device ecosystem, a display access to a file stored in a file repository associated with the network device, receive a file transfer request from a second device in the secure device ecosystem, where the file transfer request includes file identification information for the file. The processing system is also configured to cause the network device to select the file for transfer to the second device using the file identification information and output the file to the second device.

In some examples, the file repository includes a distributed context file repository distributed among one or more contributing devices in the secure device ecosystem, where the network device further includes a local context cache for the distributed context file repository, where the local context cache includes a file context for each file stored in the distributed context file repository. In some examples, the file context for each file includes an identification of the file, a reduced size version of the file, and a storage location for the file.

In some examples, the processing system is further configured to cause the network device to update the local context cache using a broadcasted context update received from at least one device of the one or more contributing devices, where the context update includes an updated file context for at least one file stored in the distributed context file repository.

In some examples, the processing system is configured to cause the network device to remove a first file context from the local context cache as a duplicate file of a second file context when a comparison of the first file context with the second file context indicates respective files associated with the first file context and the second file context are the same. In some examples, the processing system is configured to cause the network device to broadcast a context update indicating the first file context is a duplicate file of the second file context to the one or more contributing devices.

In some examples, the processing system is configured to cause the network device to receive a delete request for a local file associated with the distributed context file repository and stored on the network device and output an alert that the local file represents a stored version of the local file within the distributed context file repository.

In some examples, the processing system is further configured to cause the network device to generate a unique identification (ID) for the file, where the unique ID includes a storage location for the file within the secure device ecosystem and provide the unique ID to the first device in the secure device ecosystem. In some examples, the file identification information includes the unique ID provided to the first device and captured by the second device, and the processing system is further configured to cause the network device to select the file for transfer using the unique ID in the file identification information.

In some examples, the file includes content displayable at the first device, and selecting the file for transfer further includes parsing the file identification information to identify file content and searching the file repository using the parsed file content to associate the parsed file content with the content displayable at the first device of the file.

In some examples, the file includes an image file, where the content displayable at the first device includes image content, and where searching the file repository includes image recognition processing of the parsed file content and the image content.

Another innovative aspect of the subject matter described in this disclosure can be implemented in a device. The device includes a processing system that includes one or more processors and one or more memories coupled with the one or more processors. The processing system is configured to cause the device to request display access for a file in a secure device ecosystem, request a unique identification (ID) for the file including a storage location for the file within the secure device ecosystem and display the unique ID on an interface associated with the device.

In some aspects, the techniques described herein relate to a device, where the processing system is further configured to cause the device to receive a transfer view request from a remote device in the secure device ecosystem, where the device requests the unique ID for the file upon receiving the transfer view request.

In some examples, the unique ID includes a temporary unique ID, where the temporary unique ID expires at a termination of the display access to the file. In some examples, the unique ID also includes a machine-readable optical image.

Another innovative aspect of the subject matter described in this disclosure can be implemented in a method for wireless communication by a network device. The method includes providing, to a first device in a secure device ecosystem, a display access to a file stored in a file repository, receiving a file transfer request from a second device in the secure device ecosystem, where the file transfer request includes file identification information for the file, selecting the file for transfer to the second device using the file identification information and outputting the file to the second device.

In some examples, the file repository includes a distributed context file repository distributed among one or more contributing devices in the secure device ecosystem, where the network device further includes a local context cache for the distributed context file repository, where the local context cache includes a file context for each file stored in the distributed context file repository, and where the file context for each file includes an identification of the file, a reduced size version of the file and a storage location for the file.

In some examples, the method further includes updating the local context cache using a broadcasted context update received from at least one device of the one or more contributing devices, where the context update includes an updated file context for a least one file stored in the distributed context file repository.

In some examples, the method further includes removing a first file context from the local context cache as a duplicate file of a second file context when a comparison of the first file context with the second file context indicates respective files associated with the first file context and the second file context are the same and broadcasting a context update indicating the first file context is a duplicate file of the second file context to the one or more contributing devices.

In some examples, the method further includes receiving a delete request for a local file associated with the distributed context file repository and stored on the network device and outputting an alert that the local file represents a stored version of the local file within the distributed context file repository.

In some examples, the method further includes generating a unique identification (ID) for the file, where the unique ID includes a storage location for the file within the secure device ecosystem, providing the unique ID to the first device in the secure device ecosystem, where the file identification information includes the unique ID provided to the first device and captured by the second device, and selecting the file for transfer using the unique ID in the file identification information.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 shows a pictorial diagram of an example wireless communication network.

FIG. 2 shows a pictorial diagram of another example wireless communication network.

FIG. 3 shows a pictorial diagram of an example secure device ecosystem.

FIG. 4 shows a system flow diagram illustrating an example process that supports accessing and transferring files between devices in a secure device ecosystem.

FIG. 5 shows a pictorial diagram of an example secure device ecosystem with a distributed context file repository.

FIG. 6 shows a system flow diagram illustrating an example process that supports contributing to a distributed context cache file repository and accessing and transferring files between devices in a secure device ecosystem.

FIG. 7 shows a flowchart illustrating an example process performable by or at a wireless STA that supports accessing and transferring files between devices in a secure device ecosystem.

FIGS. 8A and 8B show flowcharts illustrating example processes performable by or at a wireless STA that supports accessing and transferring files between devices in a secure device ecosystem.

FIG. 9 shows a flowchart illustrating an example process performable by or at a display device that supports accessing and transferring files between devices in a secure device ecosystem.

FIG. 10 shows a flowchart illustrating an example process performable by or at a network device that supports accessing and transferring files between devices in a secure device ecosystem.

FIGS. 11A and 11B show flowcharts illustrating example processes performable by or at a network device that supports accessing and transferring files between devices in a secure device ecosystem.

FIG. 12 shows a block diagram of an example wireless communication device that supports accessing and transferring files between devices in a secure device ecosystem.

FIG. 13 shows a block diagram of an example wireless communication device that supports accessing and transferring files between devices in a secure device ecosystem.

Like reference numbers and designations in the various drawings indicate like elements.

### DETAILED DESCRIPTION

The following description is directed to some particular examples for the purposes of describing innovative aspects of this disclosure. However, a person having ordinary skill in the art will readily recognize that the teachings herein can be applied in a multitude of different ways. Some or all of the described examples may be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G, 5G (New Radio (NR)) or 6G standards promulgated by the 3^{rd} Generation Partnership Project (3GPP), among others.

The described examples can be implemented in any suitable device, component, system or network that is capable of transmitting and receiving RF signals according to one or more of the following technologies or techniques: code division multiple access (CDMA), time division multiple access (TDMA), orthogonal frequency division multiplexing (OFDM), frequency division multiple access (FDMA), orthogonal FDMA (OFDMA), single-carrier FDMA (SC-FDMA), spatial division multiple access (SDMA), rate-splitting multiple access (RSMA), multi-user shared access (MUSA), single-user (SU) multiple-input multiple-output (MIMO) and multi-user (MU)-MIMO (MU-MIMO). The described examples also can be implemented using other wireless communication protocols or RF signals suitable for use in one or more of a wireless personal area network (WPAN), a wireless local area network (WLAN), a wireless wide area network (WWAN), a wireless metropolitan area network (WMAN), a non-terrestrial network (NTN), or an internet of things (IoT) network.

As network connected devices increase in usage throughout every aspect of life, an increasing amount of data and files are created and shared among device users. For example, groups, such as families and friends, often capture images and videos of events and surroundings, using a variety of devices, including cameras, smartphones, tablets and drones, among many other types of devices. The images and videos are then stored in shared photo and video albums so that each member of the family may access and view the media. In some other examples, files including text documents, spreadsheets, and other types of files may be shared and accessed in a shared repository among student groups, coworkers, and other types of collaborative groups. However, manually accessing a displayed file at the central location may require the member of the group to determine a name for the file, access the server, determine a location for the file repository, and then search that location for the name of the file. In this case, the member of the group or user is required to manually intervene in each step of the file access process and the user's device and the secure device ecosystem server must devote processing and memory resources to provide the user with database/repository search and access services.

Various aspects relate to file sharing and transfer in a secure device ecosystem and, more particularly to utilizing communications with trusted devices in a secure device ecosystem to display a file at a display device and provide access to the file to a requesting device access to the file using information gathered from the display of the file. In some examples, various members of a group, such as friend group, family, coworkers, etc., may have devices that are part of a secure device ecosystem, which allows for each member of the group to share and access files in a shared file repository from their respective secure devices. For example, images and videos taken by members of the group may be added to the shared file repository from many different devices associated with the group. Additionally, other types of documents such as text documents, spreadsheets or other various files may be added to the shared file repository for access and collaboration among the group.

In some examples, the files in the shared file repository may be accessed and displayed on a device in the secure network. A member of the group viewing the displayed file also may want to access and store a copy of the file on a different device from the display device. Manually identifying the displayed file and then searching the shared file repository for the file introduces delays and inaccessibility for many users. For example, a user desiring a copy of the displayed image to be stored on their smart phone device may have to manually search the file repository and, in some cases, review each image in the shared file repository to find the desired displayed image.

Some aspects of the file sharing and transfer in a secure device ecosystem described herein relate to a network device in a secure device ecosystem which provides display access to a display device for a file stored in a file repository associated with the network device. The display access allows for the display device to display the file on an interface, such as a screen, associated with the display device. In some aspects, the network device receives a file transfer request from a requesting device in the secure device ecosystem. The file transfer request may include file identification information captured from the display device by the receiving device, such as an image of the file displayed on the interface associated with the display device. In some aspects, the file identification information may include a unique code generated by the network device to identify the file. In some additional aspects, the file identification information also may include contents of the file displayed at the display device, such as an image snapshot of the display. In some aspects, the network device also may select the file for transfer to the requesting device using the file identification information included in the file transfer request and provide a copy of the file to the requesting device.

Some additional aspects relate to the requesting device in the secure device ecosystem which captures the file identification information for the file from the interface associated with the display device. In some aspects, the requesting device also may transmit a file transfer request for the file, including the captured file identification information, to the network device associated with the file repository and receive the file from the network device for storage at the requesting device. Some additional aspects also relate to the display device in the secure device ecosystem which requests the display access for the file and displays the file on the interface associated with the display device. In some additional aspects, the display device also requests a unique identification (ID) for the file from the network device and augments the display of the file to include the unique ID.

Particular aspects of the subject matter described in this disclosure can be implemented to realize one or more of the following potential advantages. The present disclosure provides for quick file identification and transfer from a file repository or storage device to other requesting devices on a secure network. By using file identification information captured by a requesting device from the displayed file, a network device associated with the shared file repository, the requesting device, and the display device may provide for direct file sharing and transfer without requiring a user manually search through files in the file repository. In some examples, the file may include an image file, a video file, a voice file, a text file, or other multimedia file stored in the file repository. Additionally, the file repository may include an image repository, video repository, voice repository, and other multimedia file repository.

In some examples, the file identification information includes information, such as file content or a unique identification (ID) of the file, which allows for the network device to quickly select the file from the file repository and provide the file to the requesting device without needing to provide the file name or location to a user. Additionally, by utilizing devices in a secure device ecosystem for file transfer, the security of the devices and the file repository are not compromised, while also providing access and file sharing between the devices in the secure device ecosystem. Providing file transfer between devices using captured file identification information mitigates the complication and delay of manually searching for a file to transfer.

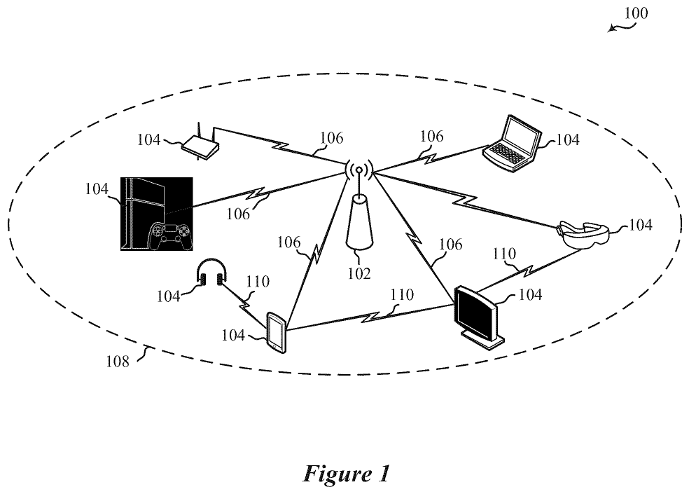

FIG. 1 shows a pictorial diagram of an example wireless communication network 100. According to some aspects, the wireless communication network 100 can be an example of a wireless local area network (WLAN) such as a Wi-Fi network. For example, the wireless communication network 100 can be a network implementing at least one of the IEEE 802.11 family of wireless communication protocol standards, such as defined by the IEEE 802.11-2020 specification or amendments thereof (including, but not limited to, 802.11ay, 802.11ax (also referred to as Wi-Fi 6), 802.11az, 802.11ba, 802.11bc, 802.11bd, 802.11be (also referred to as Wi-Fi 7), 802.11bf, and 802.11bn (also referred to as Wi-Fi 8)) or other WLAN or Wi-Fi standards, such as that associated with the Integrated Millimeter Wave (IMMW) study group. In some other examples, the wireless communication network 100 can be an example of a cellular radio access network (RAN), such as a 5G or 6G RAN that implements one or more cellular protocols such as those specified in one or more 3GPP standards. In some other examples, the wireless communication network 100 can include a WLAN that functions in an interoperable or converged manner with one or more cellular RANs to provide greater or enhanced network coverage to wireless communication devices within the wireless communication network 100 or to enable such devices to connect to a cellular network's core, such as to access the network management capabilities and functionality offered by the cellular network core. In some other examples, the wireless communication network 100 can include a WLAN that functions in an interoperable or converged manner with one or more personal area networks, such as a network implementing Bluetooth or other wireless technologies, to provide greater or enhanced network coverage or to provide or enable other capabilities, functionality, applications or services.

The wireless communication network 100 may include numerous wireless communication devices including a wireless access point (AP) 102 and any number of wireless stations (STAs) 104. While only one AP 102 is shown in FIG. 1, the wireless communication network 100 can include multiple APs 102 (for example, in an extended service set (ESS) deployment, enterprise network or AP mesh network), or may not include any AP at all (for example, in an independent basic service set (IBSS) such as a peer-to-peer (P2P) network or other ad hoc network). The AP 102 can be or represent various different types of network entities including, but not limited to, a home networking AP, an enterprise-level AP, a single-frequency AP, a dual-band simultaneous (DBS) AP, a tri-band simultaneous (TBS) AP, a standalone AP, a non-standalone AP, a software-enabled AP (soft AP), and a multi-link AP (also referred to as an AP multi-link device (MLD)), as well as cellular (such as 3GPP, 4G LTE, 5G or 6G) base stations or other cellular network nodes such as a Node B, an evolved Node B (eNB), a gNB, a transmission reception point (TRP) or another type of device or equipment included in a radio access network (RAN), including Open-RAN (O-RAN) network entities, such as a central unit (CU), a distributed unit (DU) or a radio unit (RU).

Each of the STAs 104 also may be referred to as a mobile station (MS), a mobile device, a mobile handset, a wireless handset, an access terminal (AT), a user equipment (UE), a subscriber station (SS), or a subscriber unit, among other examples. The STAs 104 may represent various devices such as mobile phones, other handheld or wearable communication devices, netbooks, notebook computers, tablet computers, laptops, Chromebooks, augmented reality (AR), virtual reality (VR), mixed reality (MR) or extended reality (XR) wireless headsets or other peripheral devices, wireless earbuds, other wearable devices, display devices (for example, TVs, computer monitors or video gaming consoles), video game controllers, navigation systems, music or other audio or stereo devices, remote control devices, printers, kitchen appliances (including smart refrigerators) or other household appliances, key fobs (for example, for passive keyless entry and start (PKES) systems), Internet of Things (IoT) devices, and vehicles, among other examples.

A single AP 102 and an associated set of STAs 104 may be referred to as an infrastructure basic service set (BSS), which is managed by the respective AP 102. FIG. 1 additionally shows an example coverage area 108 of the AP 102, which may represent a basic service area (BSA) of the wireless communication network 100. The BSS may be identified by STAs 104 and other devices by a service set identifier (SSID), as well as a basic service set identifier (BSSID), which may be a medium access control (MAC) address of the AP 102. The AP 102 may periodically broadcast beacon frames (“beacons”) including the BSSID to enable any STAs 104 within wireless range of the AP 102 to “associate” or re-associate with the AP 102 to establish a respective communication link 106 (hereinafter also referred to as a “Wi-Fi link”), or to maintain a communication link 106, with the AP 102. For example, the beacons can include an identification or indication of a primary channel used by the respective AP 102 as well as a timing synchronization function (TSF) for establishing or maintaining timing synchronization with the AP 102. The AP 102 may provide access to external networks to various STAs 104 in the wireless communication network 100 via respective communication links 106.

To establish a communication link 106 with an AP 102, each of the STAs 104 is configured to perform passive or active scanning operations (“scans”) on frequency channels in one or more frequency bands (for example, the 2.4 GHZ, 5 GHZ, 6 GHZ, 45 GHZ, or 60 GHz bands). To perform passive scanning, a STA 104 listens for beacons, which are transmitted by respective APs 102 at periodic time intervals referred to as target beacon transmission times (TBTTs). To perform active scanning, a STA 104 generates and sequentially transmits probe requests on each channel to be scanned and listens for probe responses from APs 102. Each STA 104 may identify, determine, ascertain, or select an AP 102 with which to associate in accordance with the scanning information obtained through the passive or active scans, and to perform authentication and association operations to establish a communication link 106 with the selected AP 102. The selected AP 102 assigns an association identifier (AID) to the STA 104 at the culmination of the association operations, which the AP 102 uses to track the STA 104.

As a result of the increasing ubiquity of wireless networks, a STA 104 may have the opportunity to select one of many BSSs within range of the STA 104 or to select among multiple APs 102 that together form an extended service set (ESS) including multiple connected BSSs. For example, the wireless communication network 100 may be connected to a wired or wireless distribution system that may enable multiple APs 102 to be connected in such an ESS. As such, a STA 104 can be covered by more than one AP 102 and can associate with different APs 102 at different times for different transmissions. Additionally, after association with an AP 102, a STA 104 also may periodically scan its surroundings to find a more suitable AP 102 with which to associate. For example, a STA 104 that is moving relative to its associated AP 102 may perform a “roaming” scan to find another AP 102 having more desirable network characteristics such as a greater received signal strength indicator (RSSI) or a reduced traffic load.

In some examples, STAs 104 may form networks without APs 102 or other equipment other than the STAs 104 themselves. One example of such a network is an ad hoc network (or wireless ad hoc network). Ad hoc networks may alternatively be referred to as mesh networks or peer-to-peer (P2P) networks. In some examples, ad hoc networks may be implemented within a larger network such as the wireless communication network 100. In such examples, while the STAs 104 may be capable of communicating with each other through the AP 102 using communication links 106, STAs 104 also can communicate directly with each other via direct wireless communication links 110. Additionally, two STAs 104 may communicate via a direct wireless communication link 110 regardless of whether both STAs 104 are associated with and served by the same AP 102. In such an ad hoc system, one or more of the STAs 104 may assume the role filled by the AP 102 in a BSS. Such a STA 104 may be referred to as a group owner (GO) and may coordinate transmissions within the ad hoc network. Examples of direct wireless communication links 110 include Wi-Fi Direct connections, connections established by using a Wi-Fi Tunneled Direct Link Setup (TDLS) link, and other P2P group connections.

In some networks, the AP 102 or the STAs 104, or both, may support applications associated with high throughput or low-latency requirements, or may provide lossless audio to one or more other devices. For example, the AP 102 or the STAs 104 may support applications and use cases associated with ultra-low-latency (ULL), such as ULL gaming, or streaming lossless audio and video to one or more personal audio devices (such as peripheral devices) or AR/VR/MR/XR headset devices. In scenarios in which a user uses two or more peripheral devices, the AP 102 or the STAs 104 may support an extended personal audio network enabling communication with the two or more peripheral devices. Additionally, the AP 102 and STAs 104 may support additional ULL applications such as cloud-based applications (such as VR cloud gaming) that have ULL and high throughput requirements.

As indicated above, in some implementations, the AP 102 and the STAs 104 may function and communicate (via the respective communication links 106) according to one or more of the IEEE 802.11 family of wireless communication protocol standards. These standards define the WLAN radio and baseband protocols for the physical (PHY) and MAC layers. The AP 102 and STAs 104 transmit and receive wireless communications (hereinafter also referred to as “Wi-Fi communications” or “wireless packets”) to and from one another in the form of PHY protocol data units (PPDUs).

Each PPDU is a composite structure that includes a PHY preamble and a payload that is in the form of a PHY service data unit (PSDU). The information provided in the preamble may be used by a receiving device to decode the subsequent data in the PSDU. In instances in which a PPDU is transmitted over a bonded or wideband channel, the preamble fields may be duplicated and transmitted in each of multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is associated with the particular IEEE 802.11 wireless communication protocol to be used to transmit the payload.

The APs 102 and STAs 104 in the wireless communication network 100 may transmit PPDUs over an unlicensed spectrum, which may be a portion of spectrum that includes frequency bands traditionally used by Wi-Fi technology, such as the 2.4 GHZ, 5 GHZ, 6 GHZ, 45 GHz, and 60 GHz bands. Some examples of the APs 102 and STAs 104 described herein also may communicate in other frequency bands that may support licensed or unlicensed communications. For example, the APs 102 or STAs 104, or both, also may be capable of communicating over licensed operating bands, where multiple operators may have respective licenses to operate in the same or overlapping frequency ranges. Such licensed operating bands may map to or be associated with frequency range designations of FR1 (410 MHZ-7.125 GHz), FR2 (24.25 GHz-52.6 GHZ), FR3 (7.125 GHZ-24.25 GHZ), FR4a or FR4-1 (52.6 GHZ-71 GHZ), FR4 (52.6 GHz-114.25 GHZ), and FR5 (114.25 GHZ-300 GHz).

Each of the frequency bands may include multiple sub-bands and frequency channels (also referred to as subchannels). The terms “channel” and “subchannel” may be used interchangeably herein, as each may refer to a portion of frequency spectrum within a frequency band (for example, a 20 MHz, 40 MHz, 80 MHz, or 160 MHz portion of frequency spectrum) via which communication between two or more wireless communication devices can occur. For example, PPDUs conforming to the IEEE 802.11n, 802.11ac, 802.11ax, 802.11be and 802.11bn standard amendments may be transmitted over one or more of the 2.4 GHZ, 5 GHZ, or 6 GHZ bands, each of which is divided into multiple 20 MHz channels. As such, these PPDUs are transmitted over a physical channel having a minimum bandwidth of 20 MHz, but larger channels can be formed through channel bonding. For example, PPDUs may be transmitted over physical channels having bandwidths of 40 MHZ, 80 MHZ, 160 MHZ, 240 MHZ, 320 MHZ, 480 MHz, or 640 MHz by bonding together multiple 20 MHz channels.

An AP 102 may determine or select an operating or operational bandwidth for the STAs 104 in its BSS and select a range of channels within a band to provide that operating bandwidth. For example, the AP 102 may select sixteen 20 MHz channels that collectively span an operating bandwidth of 320 MHz. Within the operating bandwidth, the AP 102 may typically select a single primary 20 MHz channel on which the AP 102 and the STAs 104 in its BSS monitor for contention-based access schemes. In some examples, the AP 102 or the STAs 104 may be capable of monitoring only a single primary 20 MHz channel for packet detection (for example, for detecting preambles of PPDUs). Conventionally, any transmission by an AP 102 or a STA 104 within a BSS must involve transmission on the primary 20 MHz channel. As such, in conventional systems, the transmitting device must contend on and win a TXOP on the primary channel to transmit anything at all. However, some APs 102 and STAs 104 supporting ultra-high reliability (UHR) communications or communication according to the IEEE 802.11bn standard amendment can be configured to operate, monitor, contend and communicate using multiple primary 20 MHz channels. Such monitoring of multiple primary 20 MHZ channels may be sequential such that responsive to determining, ascertaining or detecting that a first primary 20 MHz channel is not available, a wireless communication device may switch to monitoring and contending using a second primary 20 MHz channel. Additionally, or alternatively, a wireless communication device may be configured to monitor multiple primary 20 MHz channels in parallel. In some examples, a first primary 20 MHz channel may be referred to as a main primary (M-Primary) channel and one or more additional, second primary channels may each be referred to as an opportunistic primary (O-Primary) channel. For example, if a wireless communication device measures, identifies, ascertains, detects, or otherwise determines that the M-Primary channel is busy or occupied (such as due to an overlapping BSS (OBSS) transmission), the wireless communication device may switch to monitoring and contending on an O-Primary channel. In some examples, the M-Primary channel may be used for beaconing and serving legacy client devices and an O-Primary channel may be specifically used by non-legacy (for example, UHR- or IEEE 802.11bn-compatible) devices for opportunistic access to spectrum that may be otherwise under-utilized.

In some wireless communication systems, wireless communication between an AP 102 and an associated STA 104 can be secured. For example, either an AP 102 or a STA 104 may establish a security key for securing wireless communication between itself and the other device and may encrypt the contents of the data and management frames using the security key. In some examples, the control frame and fields within the MAC header of the data or management frames, or both, also may be secured either via encryption or via an integrity check (for example, by generating a message integrity check (MIC) for one or more relevant fields).

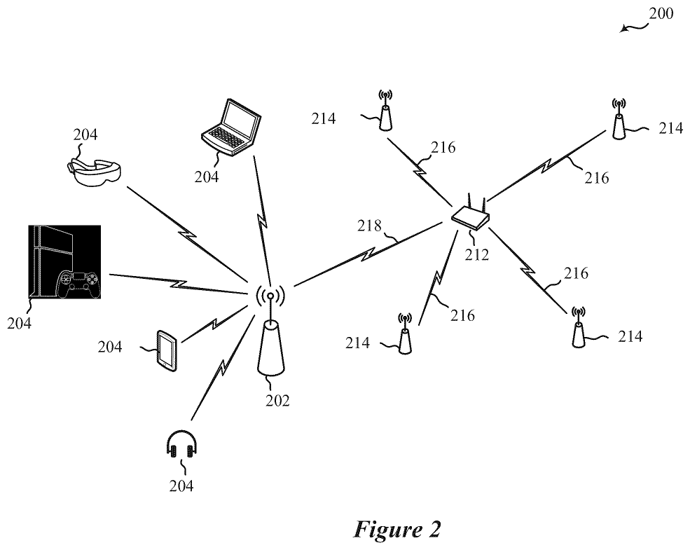

FIG. 2 shows a pictorial diagram of another example wireless communication network 200. According to some aspects, the wireless communication network 200 can be an example of a mesh network, an IoT network or a sensor network in accordance with one or more of the IEEE 802.11 family of wireless communication protocol standards (including the 802.11ah amendment). The wireless communication network 200 may include multiple wireless communication devices 214, which in some implementations may include APs 202, STAs 204, or both. The wireless communication devices 214 may represent various devices such as display devices (for example, TVs, computer monitors, navigation systems, among others), music or other audio or stereo devices, remote control devices (“remotes”), printers, kitchen or other household appliances, among other examples.

In some examples, the wireless communication devices 214 sense, measure, collect or otherwise obtain and process data and transmit such raw or processed data to an intermediate device 212 for subsequent processing or distribution. Additionally, or alternatively, the intermediate device 212 may transmit control information, digital content (for example, audio or video data), configuration information or other instructions to the wireless communication devices 214. The intermediate device 212 and the wireless communication devices 214 can communicate with one another via wireless communication links 216. In some examples, the wireless communication links 216 include Bluetooth links, or other PAN or short-range communication links.

In some examples, the intermediate device 212 also may be configured for wireless communication with other networks such as with a WLAN or a wireless (for example, cellular) wide area network (WWAN), which may, in turn, provide access to external networks including the Internet. For example, the intermediate device 212 may associate and communicate, over a Wi-Fi link 218, with an AP 202 of a wireless communication network 200, which also may serve various STAs 204. In some examples, the intermediate device 212 is an example of a network gateway, for example, an IoT gateway. In such a manner, the intermediate device 212 may serve as an edge network bridge providing a Wi-Fi core backhaul for the IoT network including the wireless communication devices 214. In some examples, the intermediate device 212 can analyze, preprocess and aggregate data received from the wireless communication devices 214 locally at the edge before transmitting it to other devices or external networks via the Wi-Fi link 218. The intermediate device 212 also can provide additional security for the IoT network and the data it transports.

Some processes, methods, operations, techniques or other aspects described herein may be implemented, at least in part, using an artificial intelligence (AI) program, such as a program that includes a machine learning (ML) or artificial neural network (ANN) model, hereinafter referred to generally as an AI/ML model. One or more AI/ML models may be implemented in wireless communication devices (for example, APs 102 and STAs 104) and to enhance various aspects associated with wireless communication. For example, an AI/ML model may be trained to identify patterns or relationships in data observed in a wireless communication network 100. An AI/ML model may support operational decisions relating to aspects associated with wireless communications networks or services. For example, an AI/ML model may be utilized for supporting or improving aspects such as reducing signaling overhead (such as by CSI feedback compression, etc.), enhancing roaming or other mobility operations, multi-AP coordination, and generally facilitating network management or optimizing network connections or characteristics to, for example, increase throughput or capacity, reduce latency or otherwise enhance user experience.

An example AI/ML model may include mathematical representations or define computing capabilities for making inferences from input data based on patterns or relationships identified in the input data. As used herein, the term “inferences” can include one or more of decisions, predictions, determinations, or values, which may represent outputs of the AI/ML model. The computing capabilities may be defined in terms of certain parameters of the AI/ML model, such as weights and biases. Weights may indicate relationships between certain input data and certain outputs of the AI/ML model, and biases are offsets that may indicate a starting point for outputs of the AI/ML model. An example AI/ML model operating on input data may start at an initial output based on the biases and then update the output based on a combination of the input data and the weights.

STAs or APs (for example, a STA 104 or an AP 102) may exchange local observations with other wireless communication devices (such as other STAs or APs) or provide feedback related to the communication. This may significantly expand the types of input data that can be considered as input to an AI/ML model, as such information may not otherwise be available at the other wireless communication devices. For example, information received from other STAs or APs may include observed RSSI values, experienced packet success/failure/retry rates per client/AP, BSS/Quality of Service (QOS) load/requirements, or a history of bad/good AP link(s), which may be conveyed in terms of scores or rankings.

AI/ML models can be centralized, distributed, or federated. As both STAs 104 and APs 102 can participate in AI/ML based operations, efficient AI/ML model distribution may enhance the performance of a wireless communication system. In some examples supporting centralized AI/ML models, STAs 104 may provide training data to a centralized network location (such as an AP, AP MLD, or a server) where a global AI/ML model may be generated and refined. The centralized network location may distribute the global AI/ML model to various STAs. In some examples, global AI/ML models may train a single classifier based on all training data received from various inputs/sources. In some examples supporting distributed learning or distributed models, both APs and STAs may be independently capable of computing AI/ML models and sharing data with other participating wireless communication devices in the wireless communication network such that each device can train the global AI/ML model locally. In some examples supporting a federated learning or hybrid AI/ML model, substantially all participating wireless communication devices (such as AP 102s and STA 104s) may be capable of generating local AI/ML models and sharing their local models to a centralized network location or entity. In turn, the centralized network entity may generate a global AI/ML model using the received local models as input and distribute the global model to all or a subset of the participating wireless communication devices.

In some examples, AI/ML models may be downloadable. For example, an AP may share AI/ML model components with associated STAs or other friendly/coordinating APs. STAs may download the AI/ML model and use the model for making decisions related to wireless communications. The downloading of an AI/ML model may be independent from signaling the inputs to the AI/ML model (for example, some wireless communication devices may download the AI/ML model without exchanging information with other wireless communication devices; some wireless communication devices may exchange information and use such information as an input to the AI/ML model without downloading it; and some wireless communication devices may download the AI/ML model and exchange information or the AI/ML model with other wireless communication devices).

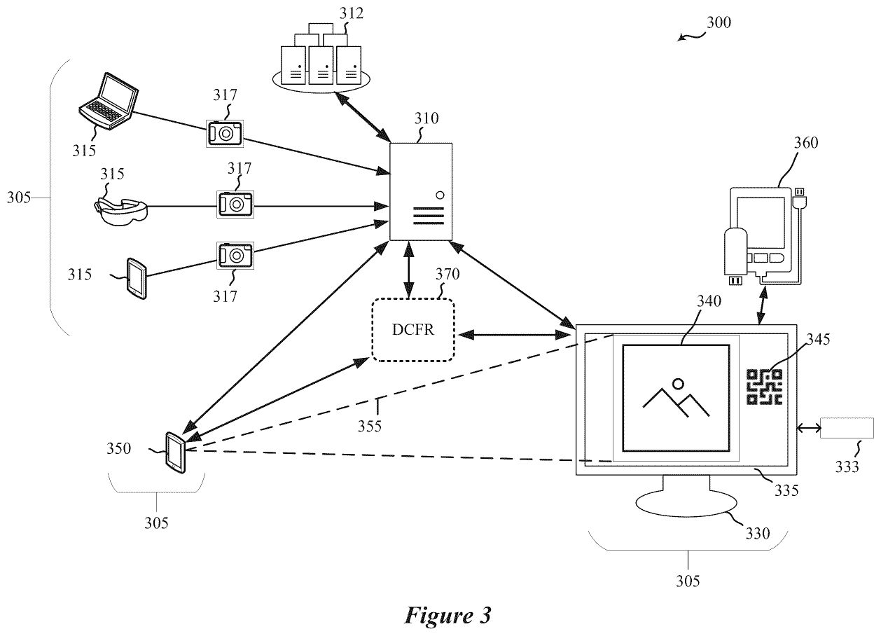

FIG. 3 shows a pictorial diagram of an example secure device ecosystem 300. In some examples, the secure device ecosystem 300 includes a secure device server 310 which services the secure device ecosystem and secure devices 305, which are authenticated to the secure device ecosystem 300. In some examples, the secure devices 305 includes various types of devices, such as upload devices 315, requesting device 350 and display device 330. In some examples, the secure devices 305 are similar to the STAs 104 and 204. For example, the secure devices 305 may be located in the coverage area 108 and communicate with a secure device server 310 via communication links 106 and AP 102 as described in further detail in reference to FIG. 1. In some examples, the secure devices 305 also may include devices outside of a coverage area 108. For example, any of the upload devices 315 may communicate with the secure device server 310 via another wireless network, such as a Wi-Fi, cellular, IoT or other wireless network. In some examples, the secure devices 305 also may communicate via communication links 110 also described with reference to FIG. 1. In some examples, communications between the secure devices 305 and the secure device server 310 or directly between respective secure devices 305 include secure or encrypted communications in the secure device ecosystem 300. For example, the STAs may communicate using secured wireless communication utilizing a security key and encrypted PPDU or other secure communication protocols.

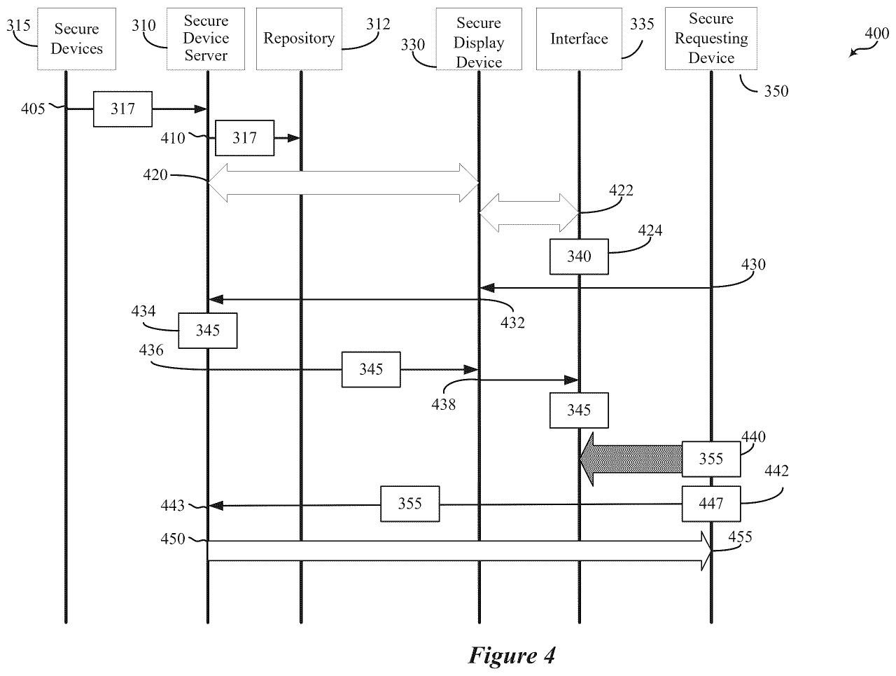

In some examples, the secure devices are authenticated to a multi-device identification service and registered to secure device server 310. In some examples, the secure device server 310 is executed on a network device such as a server, AP, such as the AP 102, or other network device in communication with the secure devices 305. For example, an independent service or ecosystem controller may authenticate a device and enroll the device in the secure device ecosystem 300. The secure devices 305 enrolled in the secure device ecosystem 300 may utilize the various wireless connections and secure communications in the secure device ecosystem 300 to perform file sharing and transfer in a secure device ecosystem, as shown in more detail in reference to FIGS. 4-11B.

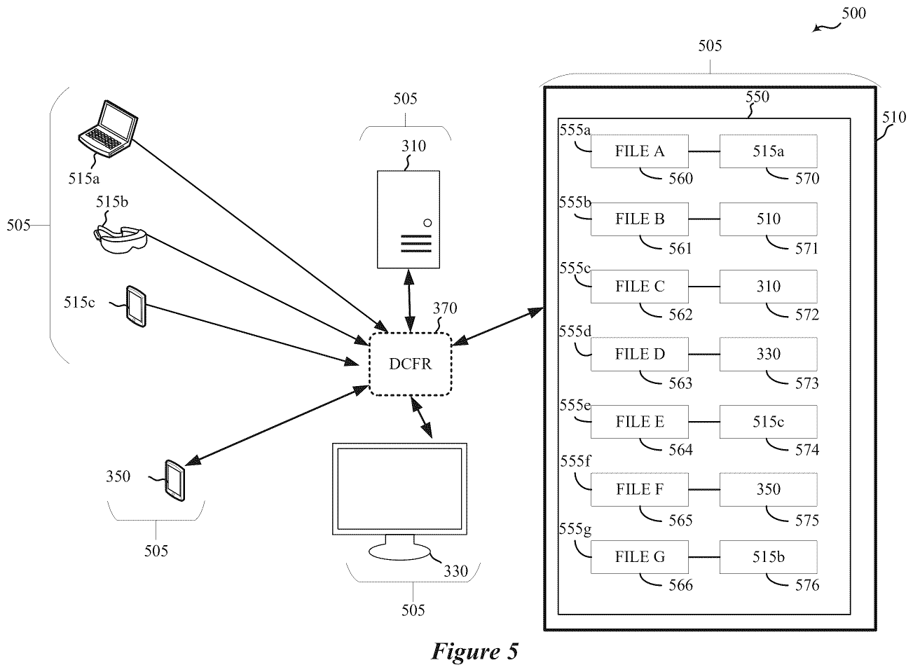

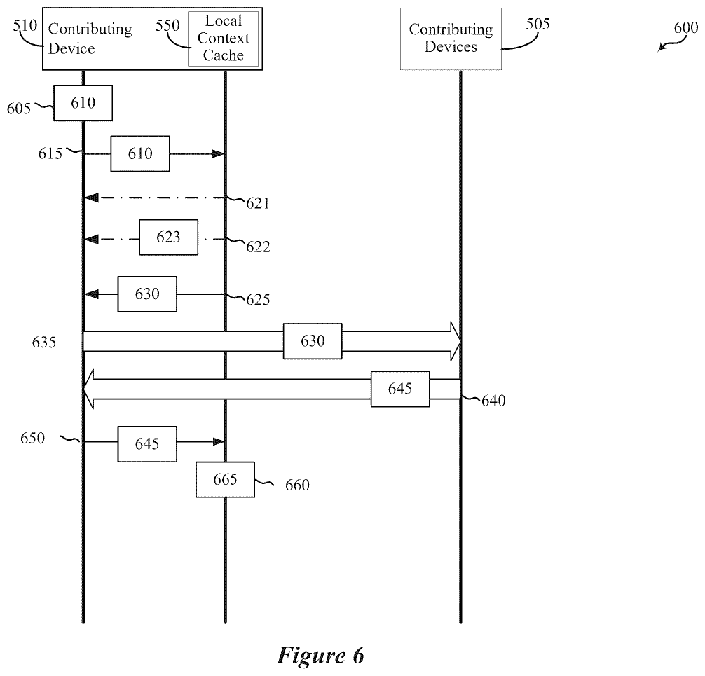

For example, the upload devices 315 may upload media files 317 to the secure device server 310 for storage as a shared album. In some examples, the secure device server 310 may store the media files 317 in a repository 312 or other virtual location. In another example, the media files 317 and other files are stored at the originating device, such as any of the secure devices 305, and are accessible to other devices and users in the secure device ecosystem 300 using a distributed context file repository (DCFR) 370 as shown in more detail in reference to FIGS. 5-6.

In some examples, the display device 330 includes an interface 335 which includes a display or other interface devices which allows the display device to display a file 340 and a unique identification (ID) 345 for the file. In some examples, the display device 330 also may communicate with a remote device 333, where the remote device 333 provides additional interface functions, such as selecting items on the interface 335. Additionally, the display device 330 may include associated storage devices 360 connected to the display device 330, where the file 340 also may be stored on the storage devices 360. In some examples, the requesting device 350 includes an image capture sensor or camera which is able to capture file identification information 355 for the file 340 displayed on the interface 335, as described in more detail in reference to FIG. 4.

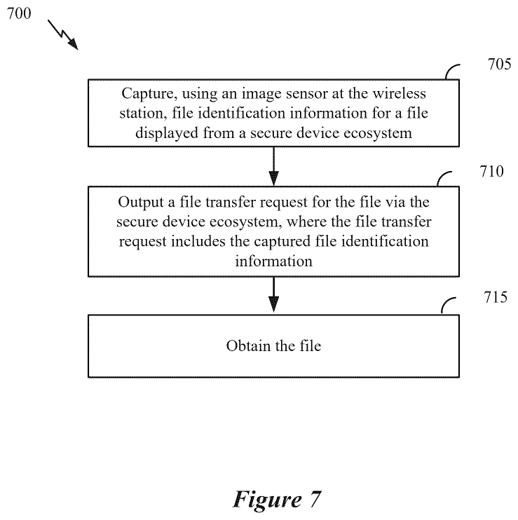

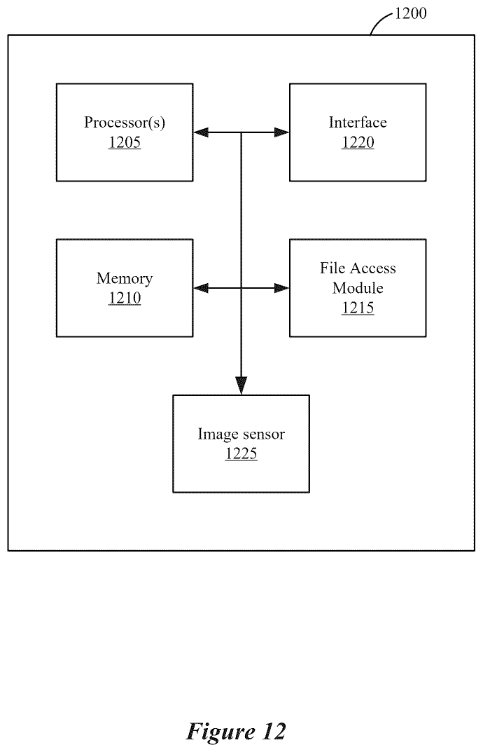

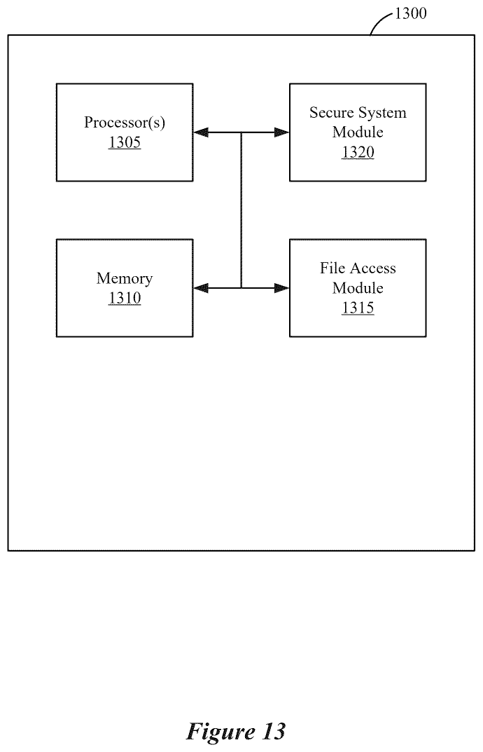

FIG. 4 shows a system flow diagram illustrating an example process 400 that supports accessing and transferring files between devices in a secure device ecosystem. The operations of the process 400 may be implemented by a wireless STAs, network devices, or associated components as described herein. For example, some operations of the process 400 may be performed by a wireless communication device, such as the wireless communication device 1200 described with reference to FIG. 12, operating as or within a wireless STA, other operations may be performed by the wireless communication device 1300 described with reference to FIG. 13. In some examples, some operations of the process 400 may be performed by various devices including a wireless STA such as one of the STAs 104 and APs 102 described with reference to FIG. 1 or by a combination of the requesting device 350, the display device 330, and the secure device server 310 described in reference to FIG. 3. Further details of the operations of the process 400 are also described in relation to the operations and examples described in reference to FIGS. 7-11B.

In some examples, the process 400 begins at time 405 where a variety of devices, such as the secure devices 305 described in reference to FIG. 3, upload files, such as media files 317, to a central repository. For example, the upload devices 315 upload images to a shared image album at the secure device server 310. In some examples, the secure device server 310 may store the media files 317 in a storage device(s), such as the repository 312 at time 410. In some examples, the repository 312 is a distributed file system, such as a cloud-based storage service or other distributed or virtual storage system. In some examples, the repository 312 is a local component or memory of the secure device server 310, where the secure device server 310 stores the media files 317 local on the secure device server 310.

In some implementations, at time 420, the display device 330 requests display access for a file in a secure device ecosystem and begins displaying the file at time 422. For example, the display device 330 may request display access to a file 340 stored at the repository 312. In some examples, display access provides a copy of the file 340 to the display device 330 for display. In some examples, the access may provide a smaller amount of data than a full copy of the file 340 to provide a display version of the file.

At time 424, the display device 330 displays the file 340 on the interface 335 associated with the display device 330. In some examples, the display is a built-in component of the display device 330, such as a built-in screen. In some examples, the interface 335 is external to the display device 330 and connected to the display device 330 via wired or wireless communication channels.

In some examples, a user of the requesting device 350 may wish to acquire a copy of the file 340 as seen displayed on the interface 335. In some examples, the user may indicate this request to the display device 330 via the requesting device 350. For example, at time 430 the requesting device 350 outputs a transfer view request to the display device 330 displaying the file. In some examples, the display device 330 receives the transfer view request from a remote device in the secure device ecosystem. For example, the transfer view request also may be sent to the display device 330 from a remote device 333 associated with the display device 330. In some examples, the transfer view request, sent from the requesting device 350 or other device from the display device 330, causes the display device 330 device to further display a unique ID for the file obtained from the secure device server 310 as shown at time 432 to time 438.

For example, at time 432, the display device 330 requests a unique ID for the file. At time 434, the secure device server 310 generates a unique identification (ID) 345 for the file. In some examples, the unique ID includes a storage location for the file within the secure device ecosystem, such as a location in the repository 312. For example, the unique ID may include a machine-readable optical image such as a barcode quick-response (QR) code. In some examples, the secure device server 310 generates the unique ID 345 to include a uniform resource locator (URL) for the file 340 in order to provide quick access to the file location to a requesting device. In some examples, the secure device server 310 generates the unique ID as a temporary unique ID, where the temporary unique ID expires at a termination of the display access to the file. For example, identifying information, such as the URL or other information may expire or terminate when the display access granted at time 420 to the display device 330 ends. In some examples, the temporary ID provides additional security and prevents accessing misidentified files at a later time after display of the file 340 has ended.

At time 436, the secure device server 310 provides the unique ID to the display device 330, and at time 438, the display device 330 displays the unique ID 345 on the interface 335. In some implementations, the display device 330 may display the QR code of the unique ID 345 along side of a display of the file 340. In some additional examples, the unique ID 345 may be displayed instead of the file 340 for a time to allow for the requesting device to capture the unique ID.

In some implementations, the requesting device 350 is within a viewing area of the display device 330 or the interface 335 such that an image sensor or camera on the requesting device 350 is able to capture image and other information from files displayed on the interface 335. As described above, a user of the requesting device 350 may see the file 340 and want to transfer the image to the requesting device 350. For example, a user may want a local copy of the file 340 or to access the file 340 to store the file 340 in another location, such as uploading to social media or cloud storage.

In some examples, at time 440, the requesting device 350 captures, using an image sensor, file identification information 355 for the file 340 displayed from the secure device ecosystem at the interface 335. For example, the requesting device 350 captures, using the image sensor, the unique ID 345 generated for the file 340 and displayed on the interface 335. In some examples, the unique ID 345 includes a storage location for the file within the secure device ecosystem generated by the secure device server 310 at time 434. In some examples, the unique ID 345 is a machine-readable optical image, such as a QR code or other similar machine-readable image. In some examples, the unique ID 345 is a temporary unique ID, where the temporary unique ID expires at a termination of the display of the file. For example, when the display device 330 proceeds to another image in the times 420 and 422, the unique ID 345 will expire and the secure device server 310 will no longer provide access to the file location for when receiving a file transfer request containing the unique ID 345.

In some examples, at time 440, the requesting device 350 may capture file content associated with the file, where the file identification information includes the captured file content. For example, identifying features of the image file including all of the image content or a subset of image content displayed as the file 340 on the interface 335 may be captured by the requesting device 350 as the file identification information.

At time 442, the requesting device 350 outputs a file transfer request for the file via the secure device ecosystem, where the file transfer request includes the captured file identification information. In some examples, the requesting device 350 may provide, via a user interface associated with the device, a visual preview of the file transfer request, including the captured file identification information and receive, via the interface, a confirmation for file transfer of the file to the requesting device 350. In some examples, the requesting device 350 outputs a file transfer request 447, including the file identification information 355 to the secure device server 310. In some examples, the requesting device 350 identifies the device server as an access or transfer point for the file 340 based on the file identification information 355, including the unique ID 345.

A time 443, the secure device server 310 receives the file transfer request 447 from the requesting device 350 in the secure device ecosystem. In some examples, the file transfer request 447 includes the file identification information 355, including the unique ID 345. At time 450, the secure device server 310 selects the file for transfer to the requesting device 350 using the file identification information and outputs the file to the requesting device 350. In some examples, the secure device server 310 selects the file for transfer using the unique ID 345 parsed from the file identification information. In some examples, the secure device server 310 parses the file identification information 355 to identify file content and searches the file repository using the parsed file content to associate the parsed file content with the content displayable at the interface 335 of the file. For example, for an image file, the secure device server 310 uses image recognition processing of the parsed file content and the image content to search the file repository for the file 340.

At time 455 the requesting device 350 obtains the file from the secure device server 310. In some examples, the file 340 or a copy of the file 340 is transferred to the requesting device 350 via various file communication/transfer means. In some examples, the requesting device 350 saves the file 340 as a local file on the requesting device 350. In some examples, the requesting device 350 saves the file 340 to a remote location, such as a cloud storage location, including social media or other file repository.

FIG. 5 shows a pictorial diagram of an example secure device ecosystem 500 with a DCFR 370. In some examples, the secure device ecosystem 500 is an example of the secure device ecosystem 300 as shown in FIG. 3. In some examples, the secure device ecosystem 500 includes the secure device server 310 which services the secure device ecosystem and secure devices, such as the secure devices 305 shown in FIG. 3, which are authenticated to the secure device ecosystem 300. In some examples, the secure devices includes various types of devices, such as contributing devices 505 which may contribute to the DCFR 370. In some examples, the contributing devices 505 also may include the requesting device 350, the display device 330, upload devices 515a-515c, and a contributing device 510.

In some implementations, each of the contributing devices 505 to the DCFR 370 maintains a local context cache for the DCFR. For example, the contributing device 510 maintains a local context cache (LCC) 550 for the DCFR 370. The LCC 550 includes a file context for each file stored in or as part of the DCFR. For example, the LCC 550 includes file contexts 555a-555g corresponding to files stored as part of the DCFR 370 at the contributing device 510 and other devices in the secure device ecosystem 500. In some examples, the file contexts 555a-555g include respective file representations 560-566 and storage locations 570-576. For example, the file context 555e for a file “FILE E” includes the file representation 564. In some examples, the file representation 564 includes an identification of the file and a reduced size version of the file. For example, a file representation of an image file may include a thumbnail or type of reduced version of the original image file. The file context 555e also includes the storage location 574 which indicates that the original file is stored or located at the contributing device 515c.

In some examples, the contributing devices 505 are similar to the STAs 104 and 204 and secure device 305. For example, the contributing devices 505 may be located in the coverage area 108 and communicate with a secure device server 310 via communication links 106 and AP 102 as described in further detail in reference to FIG. 1.

In some examples, the secure devices are authenticated to a multi-device identification service and registered to the secure device server 310. In some examples, the secure device server 310 is executed on a network device such as a server, AP, such as the AP 102, or other network device in communication with the contributing devices 505. For example, an independent service or ecosystem controller may authenticate a device and enroll the device in the secure device ecosystem 500. The contributing devices 505 enrolled in the secure device ecosystem 300 may utilize the various wireless connections and secure communications in the secure device ecosystem 500 to perform file sharing and transfer in a secure device ecosystem using the DCFR, as shown in more detail in reference to FIGS. 4-11B.

FIG. 6 shows a system flow diagram illustrating an example process 600 that supports contributing to a distributed context cache file repository and accessing and transferring files between devices in a secure device ecosystem. The operations of the process 600 may be implemented by a wireless STAs, network devices, or associated components as described herein. For example, some operations of the process 600 may be performed by a wireless communication device, such as the wireless communication device 1200 described with reference to FIG. 12, operating as or within a wireless STA, other operations may be performed by the wireless communication device 1300 described with reference to FIG. 13. In some examples, some operations of the process 600 may be performed by various devices including a wireless STA such as one of the STAs 104 and APs 102 described with reference to FIG. 1 or by a combination of the contributing device 510 and other contributing devices 505 described in reference to FIG. 5. Further details of the operations of the process 600 are also described in relation to the operations and examples described in reference to FIGS. 5-11B.

In some examples, the process 600 begins at time 605 where a device of the contributing device 505, such as the contributing device 505 described in reference to FIG. 5 receives a local update 610 for the DCFR 370. For example, a user or other entity on the contributing device 510, such as an installed application, may provide an update, such as adding, modifying, or deleting a file in the DCFR 370. At time 615, the contributing device 505 provides the update 610 to the LCC 550.

In some examples, at time 621 and when the update 610 is a delete request for a local file associated with the distributed context file repository and stored on the contributing device 510, the LCC 550, outputs an alert that the local file represents a stored version of the local file within the distributed context file repository. In some examples, the alert at time 621 notifies the contributing device 510 or the user of the device that deleting the file from the DCFR 370 may delete the file from the device.

In some examples, at time 622 the LCC 550, when the update 610 is a new file context added to the DCFR, the LCC 550, compares a first or new file context in the update 610 with stored file contexts. In some examples, when the comparison indicates respective files associated with the first file context in the update 610 and a second file context stored in the LCC 550 stored are the same, the LCC 550 outputs or broadcasts a context update 623 indicating the first file context in the update 610 is a duplicate file of the second file context to the contributing device 510 and one or more contributing devices 505.

At time 625, the LCC 550 provides an update 630 for the DCFR 370 and at time 635 the contributing device 510 broadcasts the update 630 to the device 505 that contribute to the DCFR 370. In some examples, the contributing device 510 including the LCC 550 may update the local context cache using a broadcasted context update received from at least one device of the one or more contributing devices, where the context update is an updated file context for at least one file stored in the distributed context file repository. For example, time 640, the contributing device 510 receives a broadcast update 645 from one or more of the contributing devices 505 and provides the broadcast update 645 to the LCC 550 at time 650. In some examples, at time 660 the LCC 550 updates the local cache during process 665. For example, the LCC 550 may remove a first file context from the local context cache as a duplicate file of a second file context when a comparison of the first file context with the second file context indicates respective files associated with the first file context and the second file context are the same and generate a context update indicating the first file context is a duplicate file of the second file context to the one or more contributing devices similar to the process at time 622.

In some examples, the LCC 550 also may receive a delete request for a local file associated with the distributed context file repository and stored on the network device as part of the broadcast update 645 and output an alert that the local file represents a stored version of the local file within the distributed context file repository. In some examples, the LCC 550 and the contributing device 510 also may perform additional functions using the DCFR 370 and the file contexts located in the LCC 550. For example, the contributing device 510 may generate summaries of the files located in the DCFR 370 for user review. For example, for media files, such as images or videos, the contributing device 510 and the LCC 550 may generate slideshows, videos, or other interactive presentations representing the content stored in the DCFR 370 using the file contexts on the contributing device 510.

In some examples, with reference back to the image sharing process described in the process 400 described in relation to FIG. 4, at time 442 the requesting device 350 may determine from a local context cache on the device a storage location for the file 340 and outputs a file transfer request for the file via the secure device ecosystem to location device as indicated in storage location which identifies the location device of one or more contributing devices. In some examples, the requesting device 350 outputs the file transfer request 447, including the file identification information 355 to storage location, which includes any of the contributing device 505. In some examples, the requesting device 350 identifies the device server as an access or transfer point for the file 340 based on the file identification information 355, including the unique ID 345 and the storage location in the LCC 550.

In some examples, at time 443, the location device, as indicated in the LCC 550, receives the file transfer request 447 from the requesting device 350 in the secure device ecosystem outputs the file to the requesting device 350. In this example, at time 455 the requesting device 350 obtains the file from the location device of the contributing device 505. In some examples, the file 340 or a copy of the file 340 is transferred to the requesting device 350 via various file communication/transfer means

FIG. 7 shows a flowchart illustrating an example process 700 performable by or at a wireless STA that supports accessing and transferring files between devices in a secure device ecosystem. The operations of the process 700 may be implemented by a wireless STA or its components as described herein. For example, the process 700 may be performed by a wireless communication device, such as the wireless communication device 1200 described with reference to FIG. 12, operating as or within a wireless STA. In some examples, the process 700 may be performed by a wireless STA such as one of the STAs 104 described with reference to FIG. 1 or a requesting device such as the requesting device 350 described with reference to FIGS. 3 and 4.

In some examples, in block 705, the wireless STA captures, using an image sensor at the wireless station, file identification information for a file displayed from a secure device ecosystem. In some examples, the requesting device 350 captures, using the image sensor, file content associated with the file and the file identification information includes the captured file content. For example, the file identification information may include a snapshot of content, including image content, in the file 340 for use in an image search at a server and file repository, such as the secure device server 310. In another example, the requesting device 350 may capture a unique ID for the file 340, such as the unique ID 345 as shown in reference to FIGS. 3 and 4.

At block 710, the wireless STA outputs a file transfer request for the file via the secure device ecosystem. In some aspects, the file transfer request includes captured file identification information. For example, the requesting device 350 may generate the file transfer request 447 and transmit the file transfer request to the secure device server 310.

At block 715, the wireless STA obtains the file. For example, the requesting device 350 may obtain the file 340 from the secure device server 310 via file transfer processes as described in reference to FIG. 4.

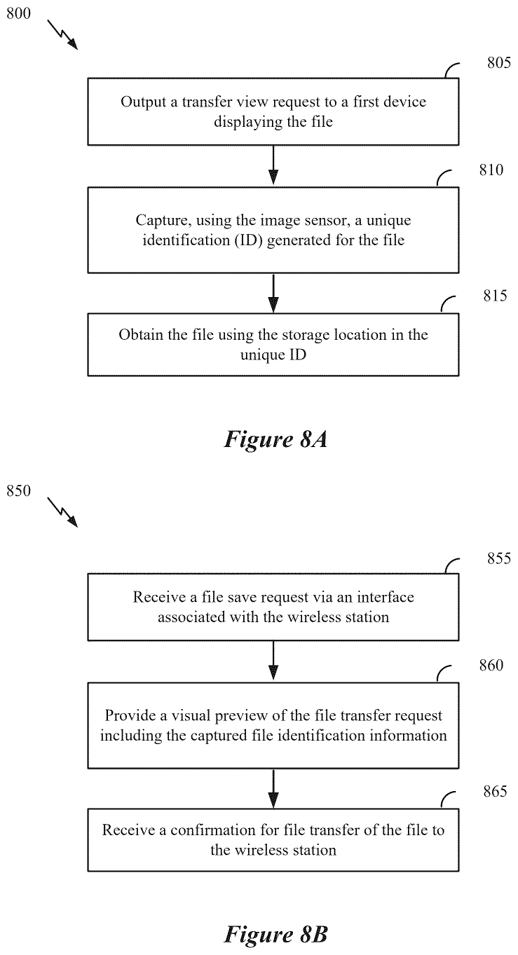

FIGS. 8A and 8B show flowcharts illustrating example processes 800 and 850 performable by or at a wireless STA that supports accessing and transferring files between devices in a secure device ecosystem. The operations of the processes 800 and 850 may be implemented by a wireless STA or its components as described herein. For example, the processes 800 and 850 may be performed by a wireless communication device, such as the wireless communication device 1200 described with reference to FIG. 12, operating as or within a wireless STA. In some examples, the processes 800 and 850 may be performed by a wireless STA such as one of the STAs 104 described with reference to FIG. 1 or a requesting device such as the requesting device 350 described with reference to FIGS. 3 and 4.

FIG. 8A shows a flowchart illustrating the example process 800 performable by or at a wireless STA that supports accessing and transferring files between devices in a secure device ecosystem. In some examples, in block 805, the wireless STA outputs a transfer view request to a first device displaying the file. In some examples, the transfer view request causes the first device, such as the display device 330 and interface 335 to further display a unique ID, such as the unique ID 345, for the file 340. In some examples, the unique ID 345 is machine-readable optical image such as a barcode or QR code. In some examples, the unique ID is a temporary unique ID which expires at a termination of the display of the file. For example, when the interface 335 stops displaying the file 340, the unique ID 345 will expire.

At block 810, the wireless STA captures, using the image sensor, the unique ID generated for the file. For example, the requesting device 350 captures the unique ID 345 as part of the file identification information 355. In some examples, the unique ID includes a storage location for the file within the secure device ecosystem.

At block 815, the wireless STA obtains the file using the storage location in the unique ID. For example, the requesting device 350 may provide the unique ID 345 to the secure device server 310 in order to access a file location for the file 340.

FIG. 8B shows a flowchart illustrating the example process 850 performable by or at a wireless STA that supports accessing and transferring files between devices in a secure device ecosystem. In some examples, in block 855, the wireless STA receives a file save request via an interface associated with the wireless station. For example, at time 430 shown in FIG. 4, the requesting device 350 may receive an indication from a user that a local copy of file 340 displayed on the interface 335 is desired at the requesting device 350.

At block 860, the wireless STA provides, via the interface, a visual preview of the file transfer request including the captured file identification information. For example, upon capturing the file identification information 355 at time 440 shown in FIG. 4, the requesting device 350 may provide a confirmation alert to a user of the requesting device 350 in order to confirm that a local copy of the file 340 is desired. At block 865, the wireless STA receives, via the interface, a confirmation for file transfer of the file to the wireless station. In some examples, upon receiving the confirmation at block 865, the requesting device proceeds with block 715 of the process 700 in obtaining the file 340.

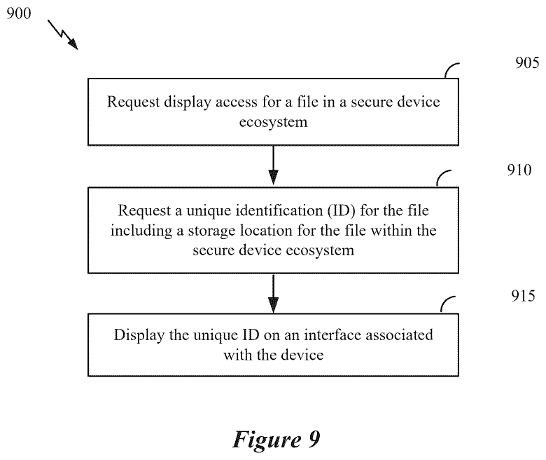

FIG. 9 shows a flowchart illustrating an example process 900 performable by or at a display device that supports accessing and transferring files between devices in a secure device ecosystem 300. The operations of the process 900 may be implemented by a wireless STA or other network device or its components as described herein. For example, the process 900 may be performed by a wireless communication device, such as the wireless communication device 1200 described with reference to FIG. 12, operating as or within a wireless STA or other network device. In some examples, the process 900 may be performed by a wireless STA such as one of the STAs 104 described with reference to FIG. 1 or a display device such as the display device 330 described with reference to FIGS. 3 and 4.

In some examples, in block 905, the display device requests display access for a file in a secure device ecosystem. In some examples, the file is an image file which includes image content displayable at the device, and the display access provides the display device access to the image content. In some examples, the display access includes access to an album or several related files and the display device 330 is able to progress through viewing each of the files in turn and display the image or other content on the interface 335.

At block 910, the display device requests a unique ID for the file. In some examples, the unique ID includes a storage location for the file within the secure device ecosystem. In some examples, the display device receives a transfer view request from a remote device in the secure device ecosystem and requests the unique ID for the file upon receiving the transfer view request. For example, the display device may receive a transfer view request from the requesting device 350 or from the remote device 333 and request the unique ID upon receiving the transfer view request.

At block 915, the display device displays the unique ID on an interface associated with the device. For example, the display device 330 may receive the unique ID 345 from the secure device server 310 and display the unique ID 345 on the interface 335. As described above in relation to FIG. 7, in some examples the unique ID is a temporary unique ID, where the temporary unique ID expires at a termination of the display access to the file. For example, when the display device 330 stops displaying the file 340, the unique ID may expire.

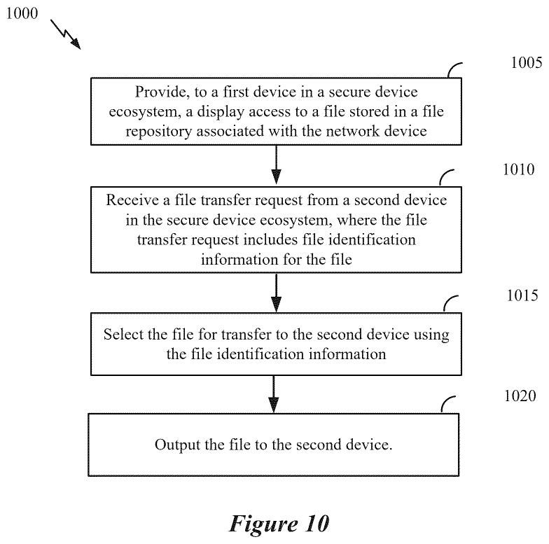

FIG. 10 shows a flowchart illustrating an example process 1000 performable by or at a network device that supports accessing and transferring files between devices in a secure device ecosystem. The operations of the process 1000 may be implemented by a wireless AP or other network device its components as described herein. For example, the process 1000 may be performed by a wireless communication device, such as the wireless communication device 1300 described with reference to FIG. 13, operating as or within a wireless AP or other network device. In some examples, the process 1000 may be performed by a wireless AP such as one of the APs 102 described with reference to FIG. 1 or a network device such as the secure device server 310 described with reference to FIGS. 3 and 4.

In some examples, in block 1005, the network device provides, to a first device in a secure device ecosystem, a display access to a file stored in a file repository associated with the network device. In some examples, the file repository includes a plurality of files received from a plurality of devices in the secure device ecosystem, such as the files 317 received from the upload device 315.

At block 1010, the network device receives a file transfer request from a second device in the secure device ecosystem, where the file transfer request includes file identification information for the file. For example, as shown at time 443 in FIG. 4, the secure device server 310 may receive a file transfer request 447 which includes file identification information 355 captured at the requesting device 350.

At block 1015, the network device selects the file for transfer to the second device using the file identification information and outputs the file to the second device at block 1020. For example, the secure device server 310 may select the file 340 shown in FIGS. 3 and 4 for transfer to the requesting device 350 based on the file transfer request 447 and the file identification information 355 and output the file to the requesting device 350.

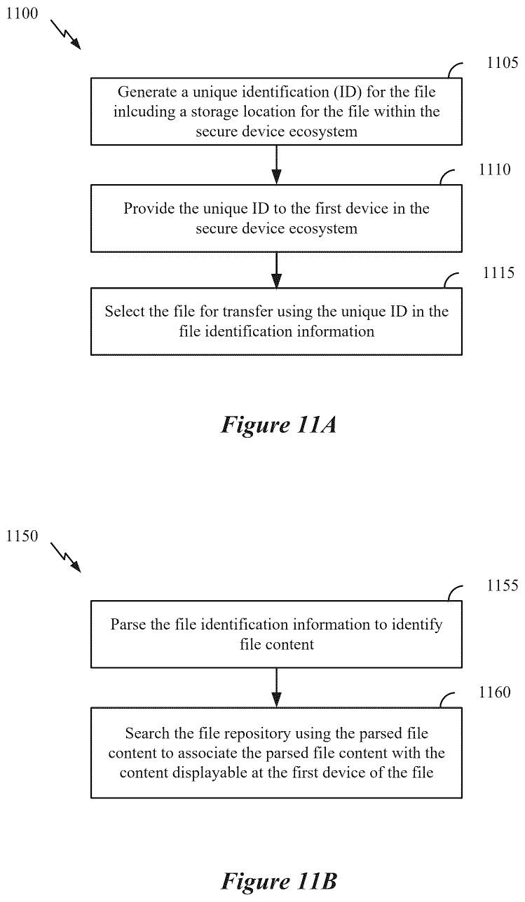

FIGS. 11A and 11B show flowcharts illustrating example processes 1100 and 1150 performable by or at a network device that supports accessing and transferring files between devices in a secure device ecosystem. The operations of the processes 1100 and 1150 may be implemented by a wireless AP or other network device its components as described herein. For example, the processes 1100 and 1150 may be performed by a wireless communication device, such as the wireless communication device 1300 described with reference to FIG. 13, operating as or within a wireless AP or other network device. In some examples, the processes 1100 and 1150 may be performed by a wireless AP such as one of the APs 102 described with reference to FIG. 1 or a network device such as the secure device server 310 described with reference to FIGS. 3 and 4.

FIG. 11A shows a flowchart illustrating the example process 1100 performable by or at a network device that supports accessing and transferring files between devices in a secure device ecosystem. In some examples, in block 1105, the network device generates a unique identification (ID) for the file. In some examples, the unique ID includes a storage location for the file within the secure device ecosystem.

At block 1110, the network device provides the unique ID to the first device in the secure device ecosystem, where the file identification information includes the unique ID provided to the first device and captured by the second device. For example, the file identification information 355 may include the unique ID 345 captured by the requesting device 350.

At block 1115, the network device selects the file for transfer using the unique ID in the file identification information. For example, the secure device server 310 may select the file 340 from the repository 312 using a URL or other location information based on the unique ID 345 requested form the requesting device 350.

FIG. 11B shows a flowchart illustrating the example process 1150 performable by or at a network device that supports accessing and transferring files between devices in a secure device ecosystem. In some examples, in block 1155, the network device parses the file identification information to identify file content. For example, when the file 340 is an image file, the secure device server 310 may utilize image recognition processes to identify various unique or identifiable aspects of the file identification information 355 to search the repository 312 for the file 340.

At block 1160, the network device searches the file repository using the image recognition processing of the parsed file content and the image content. For example, the secure device server 310 may utilize the identified unique aspects of the file identification information 355 to identify the file 340 for transfer to the requesting device 350.

FIG. 12 shows a block diagram of an example wireless communication device 1200 that supports accessing and transferring files between devices in a secure device ecosystem. In some examples, the wireless communication device 1200 is configured to perform the processes 700, 800, 850 and 900 described with reference to FIGS. 7, 8A and 8B. The wireless communication device 1200 may include one or more chips, SoCs, chipsets, packages, components or devices that individually or collectively constitute or include a processing system. The processing system may interface with other components of the wireless communication device 1200 and may generally process information (such as inputs or signals) received from such other components and output information (such as outputs or signals) to such other components. In some aspects, an example chip may include a processing system, a first interface to output or transmit information and a second interface to receive or obtain information. For example, the first interface may refer to an interface between the processing system of the chip and a transmission component, such that the device 1200 may transmit the information output from the chip. In such an example, the second interface may refer to an interface between the processing system of the chip and a reception component, such that the device 1200 may receive information that is passed to the processing system. In some such examples, the first interface also may obtain information, such as from the transmission component, and the second interface also may output information, such as to the reception component.

The processing system includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled with one or more of the processors and may individually or collectively store processor-executable code that, when executed by one or more of the processors, may configure one or more of the processors to perform various functions or operations described herein. Additionally, or alternatively, in some examples, one or more of the processors may be preconfigured to perform various functions or operations described herein without requiring configuration by software. The processing system may further include or be coupled with one or more modems (such as a Wi-Fi (for example, IEEE compliant) modem or a cellular (for example, 3GPP 4G LTE, 5G or 6G compliant) modem). In some implementations, one or more processors of the processing system include or implement one or more of the modems. The processing system may further include or be coupled with multiple radios (collectively “the radio”), multiple RF chains or multiple transceivers, each of which may in turn be coupled with one or more of multiple antennas. In some implementations, one or more processors of the processing system include or implement one or more of the radios, RF chains or transceivers.

In some examples, the wireless communication device 1200 can be configurable or configured for use in a STA, such as the STA 104 described with reference to FIG. 1. In some other examples, the wireless communication device 1200 can be a STA that includes such a processing system and other components including multiple antennas. The wireless communication device 1200 is capable of transmitting and receiving wireless communications in the form of, for example, wireless packets. For example, the wireless communication device 1200 can be configurable or configured to transmit and receive packets in the form of physical layer PPDUs and MPDUs conforming to one or more of the IEEE 1002.11 family of wireless communication protocol standards. In some other examples, the wireless communication device 1200 can be configurable or configured to transmit and receive signals and communications conforming to one or more 3GPP specifications including those for 5G NR or 6G. In some examples, the wireless communication device 1200 also includes or can be coupled with one or more application processors which may be further coupled with one or more other memories. In some examples, the wireless communication device 1200 further includes a user interface (UI) (such as a touchscreen or keypad) and a display, which may be integrated with the UI to form a touchscreen display that is coupled with the processing system. In some examples, the wireless communication device 1200 may further include one or more sensors such as, for example, one or more inertial sensors, accelerometers, temperature sensors, pressure sensors, or altitude sensors, that are coupled with the processing system.

The wireless communication device 1200 includes a processor component 1205, a memory component 1210, a file access module component 1215, and image sensor 1225, and an interface component 1220. Portions of one or more of the components 1205, 1210, 1215 and 1220 may be implemented at least in part in hardware or firmware. For example, the components 1205 and 1210 may be implemented at least in part by a processor or a modem. In some examples, portions of one or more of the components 1215 and 1220 may be implemented at least in part by a processor and software in the form of processor-executable code stored in the memory.

FIG. 13 shows a block diagram of an example wireless communication device 1300 that supports accessing and transferring files between devices in a secure device ecosystem. In some examples, the wireless communication device 1300 is configured to perform the processes 10001000, 100 and 1150 described with reference to FIGS. 10, 11A and 11B. The wireless communication device 1300 may include one or more chips, SoCs, chipsets, packages, components or devices that individually or collectively constitute or include a processing system. The processing system may interface with other components of the wireless communication device 1300 and may generally process information (such as inputs or signals) received from such other components and output information (such as outputs or signals) to such other components. In some aspects, an example chip may include a processing system, a first interface to output or transmit information and a second interface to receive or obtain information. For example, the first interface may refer to an interface between the processing system of the chip and a transmission component, such that the device 1300 may transmit the information output from the chip. In such an example, the second interface may refer to an interface between the processing system of the chip and a reception component, such that the device 1300 may receive information that is passed to the processing system. In some such examples, the first interface also may obtain information, such as from the transmission component, and the second interface also may output information, such as to the reception component.

The processing system of the wireless communication device 1300 includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled with one or more of the processors and may individually or collectively store processor-executable code that, when executed by one or more of the processors, may configure one or more of the processors to perform various functions or operations described herein. Additionally, or alternatively, in some examples, one or more of the processors may be preconfigured to perform various functions or operations described herein without requiring configuration by software. The processing system may further include or be coupled with one or more modems (such as a Wi-Fi (for example, IEEE compliant) modem or a cellular (for example, 3GPP 4G LTE, 5G or 6G compliant) modem). In some implementations, one or more processors of the processing system include or implement one or more of the modems. The processing system may further include or be coupled with multiple radios (collectively “the radio”), multiple RF chains or multiple transceivers, each of which may in turn be coupled with one or more of multiple antennas. In some implementations, one or more processors of the processing system include or implement one or more of the radios, RF chains or transceivers.

In some examples, the wireless communication device 1300 can be configurable or configured for use in an AP, such as the AP 102 described with reference to FIG. 1. In some other examples, the wireless communication device 1300 can be an AP that includes such a processing system and other components including multiple antennas. The wireless communication device 1300 is capable of transmitting and receiving wireless communications in the form of, for example, wireless packets. For example, the wireless communication device 1300 can be configurable or configured to transmit and receive packets in the form of physical layer PPDUs and MPDUs conforming to one or more of the IEEE 1002.11 family of wireless communication protocol standards. In some other examples, the wireless communication device 1300 can be configurable or configured to transmit and receive signals and communications conforming to one or more 3GPP specifications including those for 5G NR or 6G. In some examples, the wireless communication device 1300 also includes or can be coupled with one or more application processors which may be further coupled with one or more other memories. In some examples, the wireless communication device 1300 further includes at least one external network interface coupled with the processing system that enables communication with a core network or backhaul network that enables the wireless communication device 1300 to gain access to external networks including the Internet.

The wireless communication device 1300 includes a processor component 1305, a memory component 1310, a file access module component 1315 and secure system component 1320. Portions of one or more of the components 1305, 1310, 1315 and 1320 may be implemented at least in part in hardware or firmware. For example, the components 1205 and 1310 may be implemented at least in part by a processor or a modem. In some examples, portions of one or more of the components 1315 and 1320 may be implemented at least in part by a processor and software in the form of processor-executable code stored in the memory.

Implementation examples are described in the following numbered clauses:

Clause 1. A wireless station, including: a processing system that includes one or more processors and one or more memories coupled with the one or more processors, the processing system configured to cause the wireless station to: capture, using an image sensor at the wireless station, file identification information for a file displayed from a secure device ecosystem; output a file transfer request for the file via the secure device ecosystem, where the file transfer request includes the captured file identification information; and obtain the file.

Clause 2. The wireless station of clause 1, where the processing system is further configured to cause the wireless station to: capture, using the image sensor, a unique identification (ID) generated for the file, where the unique ID includes a storage location for the file within the secure device ecosystem, and where the file identification information includes the unique ID; and obtain the file using the storage location in the unique ID.

Clause 3. The wireless station of any of clauses 1 or 2, where the file is a component of a distributed context file repository distributed among one or more contributing devices in the secure device ecosystem, where the storage location identifies the storage location at a location device of the one or more contributing devices; and where the processing system is further configured to cause the wireless station to: obtain the file from the location device.

Clause 4. The wireless station of any of clauses 1, 2 or 3, where the processing system is further configured to cause the wireless station to: output a transfer view request to a first device displaying the file, where the transfer view request causes the first device to further display the unique ID for the file.

Clause 5. The wireless station of any of clauses 1, 2, 3, or 4, where the unique ID includes a temporary unique ID, and where the temporary unique ID expires at a termination of the display of the file.

Clause 6. The wireless station of any of clauses 1, 2, 3, 4 or 5, where the unique ID includes a machine-readable optical image.

Clause 7. The wireless station of any of clauses 1, 2, 3, 4, 5 or 6, where the processing system is further configured to cause the wireless station to: capture, using the image sensor, file content associated with the file, where the file identification information includes the captured file content.

Clause 8. The wireless station of any of clauses 1, 2, 3, 4, 5, 6 or 7, where the file includes an image file, and where the file content includes image content representing the displayed image file.

Clause 9. The wireless station of any of clauses 1, 2, 3, 4, 5, 6, 7 or 8, where the processing system is further configured to cause the wireless station to: receive a file save request via an interface associated with the wireless station; provide, via the interface, a visual preview of the file transfer request including the captured file identification information; and receive, via the interface, a confirmation for file transfer of the file to the wireless station.

Clause 10. A network device, including: a processing system that includes one or more processors and one or more memories coupled with the one or more processors, the processing system configured to cause the network device to: provide, to a first device in a secure device ecosystem, a display access to a file stored in a file repository associated with the network device; receive a file transfer request from a second device in the secure device ecosystem, where the file transfer request includes file identification information for the file; select the file for transfer to the second device using the file identification information; and output the file to the second device.

Clause 11. The network device of clause 10, where the file repository includes a distributed context file repository distributed among one or more contributing devices in the secure device ecosystem, where the network device further includes a local context cache for the distributed context file repository, where the local context cache includes a file context for each file stored in the distributed context file repository, and where the file context for each file includes: an identification of the file; a reduced size version of the file; and a storage location for the file.

Clause 12. The network device of any of clauses 10 or 11, where the processing system is configured to cause the network device to: update the local context cache using a broadcasted context update received from at least one device of the one or more contributing devices, where the context update includes an updated file context for at least one file stored in the distributed context file repository.

Clause 13. The network device of any of clauses 10, 11 or 12, where the processing system is configured to cause the network device to: remove a first file context from the local context cache as a duplicate file of a second file context when a comparison of the first file context with the second file context indicates respective files associated with the first file context and the second file context are the same; and broadcast a context update indicating the first file context is a duplicate file of the second file context to the one or more contributing devices.

Clause 14. The network device of any of clauses 10, 11, 12 or 13, where the processing system is configured to cause the network device to: receive a delete request for a local file associated with the distributed context file repository and stored on the network device; and output an alert that the local file represents a stored version of the local file within the distributed context file repository.

Clause 15. The network device of any of clauses 10, 11, 12, 13 or 14, where the processing system is further configured to cause the network device to: generate a unique identification (ID) for the file, where the unique ID includes a storage location for the file within the secure device ecosystem; provide the unique ID to the first device in the secure device ecosystem, where the file identification information includes the unique ID provided to the first device and captured by the second device, and select the file for transfer using the unique ID in the file identification information.

Clause 16. The network device of any of clauses 10, 11, 12, 13, 14 or 15, where the unique ID includes a temporary unique ID, where the temporary unique ID expires at a termination of the display access to the file.

Clause 17. The network device of any of clauses 10, 11, 12, 13, 14, 15 or 16, where the unique ID includes a machine-readable optical image.

Clause 18. The network device of any of clauses 10, 11, 12, 13, 14, 14, 15, 16 or 17, where the file includes content displayable at the first device, and where selecting the file for transfer further includes: parsing the file identification information to identify file content; and searching the file repository using the parsed file content to associate the parsed file content with the content displayable at the first device of the file.

Clause 19. The network device of any of clauses 10, 11, 12, 13, 14, 15, 16, 17 or 18, where the file includes an image file, where the content displayable at the first device includes image content, and where searching the file repository includes image recognition processing of the parsed file content and the image content.

Clause 20. A device, including: a processing system that includes one or more processors and one or more memories coupled with the one or more processors, the processing system configured to cause the device to: request display access for a file in a secure device ecosystem; request a unique identification (ID) for the file including a storage location for the file within the secure device ecosystem; and display the unique ID on an interface associated with the device.

Clause 21. The device of clause 20, where the processing system is further configured to cause the device to: receive a transfer view request from a remote device in the secure device ecosystem, where the device requests the unique ID for the file upon receiving the transfer view request.

Clause 22. The device of any of clauses 20 or 21, where the unique ID includes a temporary unique ID, where the temporary unique ID expires at a termination of the display access to the file.

Clause 23. The device of any of clauses 20, 21 or 22, where the unique ID includes a machine-readable optical image.

Clause 24. The device of any of clauses 20, 21, 22 or 23, where the file includes an image file including image content displayable at the device, and where the display access provides the device access to the image content.

Clause 25. A method for wireless communication by a network device, including: providing, to a first device in a secure device ecosystem, a display access to a file stored in a file repository; receiving a file transfer request from a second device in the secure device ecosystem, where the file transfer request includes file identification information for the file; selecting the file for transfer to the second device using the file identification information; and outputting the file to the second device.

Clause 26. The method of clause 25, where the file repository includes a distributed context file repository distributed among one or more contributing devices in the secure device ecosystem, where the network device further includes a local context cache for the distributed context file repository, where the local context cache includes a file context for each file stored in the distributed context file repository, and where the file context for each file includes: an identification of the file; a reduced size version of the file; and a storage location for the file.

Clause 27. The method of any of clauses 25 or 26, where the method further includes: updating the local context cache using a broadcasted context update received from at least one device of the one or more contributing devices, where the context update includes an updated file context for a least one file stored in the distributed context file repository.

Clause 28. The method of any of clauses 25, 26 or 27, where the method further includes: removing a first file context from the local context cache as a duplicate file of a second file context when a comparison of the first file context with the second file context indicates respective files associated with the first file context and the second file context are the same; and broadcasting a context update indicating the first file context is a duplicate file of the second file context to the one or more contributing devices.

Clause 29. The method of any of clauses 25, 26, 27 or 28, where method further includes: receiving a delete request for a local file associated with the distributed context file repository and stored on the network device; and outputting an alert that the local file represents a stored version of the local file within the distributed context file repository.

Clause 30. The method of any of clauses 25, 26, 27, 28 or 29, where the method further includes: generating a unique identification (ID) for the file, where the unique ID includes a storage location for the file within the secure device ecosystem; providing the unique ID to the first device in the secure device ecosystem, where the file identification information includes the unique ID provided to the first device and captured by the second device, and selecting the file for transfer using the unique ID in the file identification information.

As used herein, the term “determine” or “determining” encompasses a wide variety of actions and, therefore, “determining” can include calculating, computing, processing, deriving, estimating, investigating, looking up (such as via looking up in a table, a database, or another data structure), inferring, ascertaining, or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing and other such similar actions.

As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. As used herein, “or” is intended to be interpreted in the inclusive sense, unless otherwise explicitly indicated. For example, “a or b” may include a only, b only, or a combination of a and b. Furthermore, as used herein, a phrase referring to “a” or “an” element refers to one or more of such elements acting individually or collectively to perform the recited function(s). Additionally, a “set” refers to one or more items, and a “subset” refers to less than a whole set, but non-empty.

As used herein, “based on” is intended to be interpreted in the inclusive sense, unless otherwise explicitly indicated. For example, “based on” may be used interchangeably with “based at least in part on,” “associated with,” “in association with,” or “in accordance with” unless otherwise explicitly indicated. Specifically, unless a phrase refers to “based on only ‘a,’” or the equivalent in context, whatever it is that is “based on ‘a,’” or “based at least in part on ‘a,’” may be based on “a” alone or based on a combination of “a” and one or more other factors, conditions, or information.

The various illustrative components, logic, logical blocks, modules, circuits, operations, and algorithm processes described in connection with the examples disclosed herein may be implemented as electronic hardware, firmware, software, or combinations of hardware, firmware, or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

Various modifications to the examples described in this disclosure may be readily apparent to persons having ordinary skill in the art, and the generic principles defined herein may be applied to other examples without departing from the spirit or scope of this disclosure. Thus, the claims are not intended to be limited to the examples shown herein, but are to be accorded the widest scope consistent with this disclosure, the principles and the novel features disclosed herein.

Additionally, various features that are described in this specification in the context of separate examples also can be implemented in combination in a single implementation. Conversely, various features that are described in the context of a single implementation also can be implemented in multiple examples separately or in any suitable subcombination. As such, although features may be described above as acting in particular combinations, and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the examples described above should not be understood as requiring such separation in all examples, and it should be understood that the described program components and systems can generally be integrated together in a single software product or packaged into multiple software products.

What is claimed is:

1. A wireless station, comprising:
a processing system that includes one or more processors and one or more memories coupled with the one or more processors, the processing system configured to cause the wireless station to:
capture, using an image sensor at the wireless station, file identification information for a file displayed from a secure device ecosystem;
output a file transfer request for the file via the secure device ecosystem, where the file transfer request comprises the captured file identification information; and
obtain the file.

2. The wireless station of claim 1, wherein the processing system is further configured to cause the wireless station to:
capture, using the image sensor, a unique identification (ID) generated for the file, wherein the unique ID comprises a storage location for the file within the secure device ecosystem, and wherein the file identification information comprises the unique ID; and
obtain the file using the storage location in the unique ID.

3. The wireless station of claim 2,
wherein the file is a component of a distributed context file repository distributed among one or more contributing devices in the secure device ecosystem,
wherein the storage location identifies the storage location at a location device of the one or more contributing devices; and
wherein the processing system is further configured to cause the wireless station to:
obtain the file from the location device.

4. The wireless station of claim 2, wherein the processing system is further configured to cause the wireless station to:
output a transfer view request to a first device displaying the file, wherein the transfer view request causes the first device to further display the unique ID for the file.

5. The wireless station of claim 2, wherein the unique ID comprises a temporary unique ID, and wherein the temporary unique ID expires at a termination of the display of the file.

6. The wireless station of claim 2, wherein the unique ID comprises a machine-readable optical image.

7. The wireless station of claim 1, wherein the processing system is further configured to cause the wireless station to:
capture, using the image sensor, file content associated with the file, wherein the file identification information comprises the captured file content.

8. The wireless station of claim 7,
wherein the file comprises an image file, and
wherein the file content comprises image content representing the displayed image file.

9. The wireless station of claim 1, wherein the processing system is further configured to cause the wireless station to:
receive a file save request via an interface associated with the wireless station;
provide, via the interface, a visual preview of the file transfer request comprising the captured file identification information; and
receive, via the interface, a confirmation for file transfer of the file to the wireless station.

10. A network device, comprising:
a processing system that includes one or more processors and one or more memories coupled with the one or more processors, the processing system configured to cause the network device to:
provide, to a first device in a secure device ecosystem, a display access to a file stored in a file repository associated with the network device;
receive a file transfer request from a second device in the secure device ecosystem, where the file transfer request comprises file identification information for the file;
select the file for transfer to the second device using the file identification information; and
output the file to the second device.

11. The network device of claim 10,
wherein the file repository comprises a distributed context file repository distributed among one or more contributing devices in the secure device ecosystem,
wherein the network device further comprises a local context cache for the distributed context file repository,
wherein the local context cache comprises a file context for each file stored in the distributed context file repository, and
wherein the file context for each file comprises:
an identification of the file;
a reduced size version of the file; and
a storage location for the file.

12. The network device of claim 11, wherein the processing system is configured to cause the network device to:
update the local context cache using a broadcasted context update received from at least one device of the one or more contributing devices, wherein the context update comprises an updated file context for at least one file stored in the distributed context file repository.

13. The network device of claim 11, wherein the processing system is configured to cause the network device to:
remove a first file context from the local context cache as a duplicate file of a second file context when a comparison of the first file context with the second file context indicates respective files associated with the first file context and the second file context are the same; and
broadcast a context update indicating the first file context is a duplicate file of the second file context to the one or more contributing devices.

14. The network device of claim 11, wherein the processing system is configured to cause the network device to:
receive a delete request for a local file associated with the distributed context file repository and stored on the network device; and
output an alert that the local file represents a stored version of the local file within the distributed context file repository.

15. The network device of claim 10, wherein the processing system is further configured to cause the network device to:
generate a unique identification (ID) for the file, wherein the unique ID comprises a storage location for the file within the secure device ecosystem;
provide the unique ID to the first device in the secure device ecosystem, wherein the file identification information comprises the unique ID provided to the first device and captured by the second device, and
select the file for transfer using the unique ID in the file identification information.

16. The network device of claim 15, wherein the unique ID comprises a temporary unique ID, wherein the temporary unique ID expires at a termination of the display access to the file.

17. The network device of claim 15, wherein the unique ID comprises a machine-readable optical image.

18. The network device of claim 10,
wherein the file comprises content displayable at the first device, and
wherein selecting the file for transfer further comprises:
parsing the file identification information to identify file content; and
searching the file repository using the parsed file content to associate the parsed file content with the content displayable at the first device of the file.

19. The network device of claim 18,
wherein the file comprises an image file,
wherein the content displayable at the first device comprises image content, and
wherein searching the file repository comprises image recognition processing of the parsed file content and the image content.

20. A device, comprising:
a processing system that includes one or more processors and one or more memories coupled with the one or more processors, the processing system configured to cause the device to:
request display access for a file in a secure device ecosystem;
request a unique identification (ID) for the file comprising a storage location for the file within the secure device ecosystem; and
display the unique ID on an interface associated with the device.

21. The device of claim 20, wherein the processing system is further configured to cause the device to:
receive a transfer view request from a remote device in the secure device ecosystem, wherein the device requests the unique ID for the file upon receiving the transfer view request.

22. The device of claim 20, wherein the unique ID comprises a temporary unique ID, wherein the temporary unique ID expires at a termination of the display access to the file.

23. The device of claim 20, wherein the unique ID comprises a machine-readable optical image.

24. The device of claim 20,
wherein the file comprises an image file comprising image content displayable at the device, and
wherein the display access provides the device access to the image content.

25. A method for wireless communication by a network device, comprising:
providing, to a first device in a secure device ecosystem, a display access to a file stored in a file repository;
receiving a file transfer request from a second device in the secure device ecosystem, where the file transfer request comprises file identification information for the file;
selecting the file for transfer to the second device using the file identification information; and
outputting the file to the second device.

26. The method of claim 25,
wherein the file repository comprises a distributed context file repository distributed among one or more contributing devices in the secure device ecosystem,
wherein the network device further comprises a local context cache for the distributed context file repository,
wherein the local context cache comprises a file context for each file stored in the distributed context file repository, and
wherein the file context for each file comprises:
an identification of the file;
a reduced size version of the file; and
a storage location for the file.

27. The method of claim 26, wherein the method further comprises:
updating the local context cache using a broadcasted context update received from at least one device of the one or more contributing devices, wherein the context update comprises an updated file context for a least one file stored in the distributed context file repository.

28. The method of claim 26, wherein the method further comprises:
removing a first file context from the local context cache as a duplicate file of a second file context when a comparison of the first file context with the second file context indicates respective files associated with the first file context and the second file context are the same; and
broadcasting a context update indicating the first file context is a duplicate file of the second file context to the one or more contributing devices.

29. The method of claim 26, wherein method further comprises:
receiving a delete request for a local file associated with the distributed context file repository and stored on the network device; and
outputting an alert that the local file represents a stored version of the local file within the distributed context file repository.

30. The method of claim 25, wherein the method further comprises:
generating a unique identification (ID) for the file, wherein the unique ID comprises a storage location for the file within the secure device ecosystem;
providing the unique ID to the first device in the secure device ecosystem, wherein the file identification information comprises the unique ID provided to the first device and captured by the second device, and
selecting the file for transfer using the unique ID in the file identification information.
